(19) United States
(12) Patent Application Publication
(10) Pub. No.: US 2005/0144187 A1
(43) Pub. Date: Jun. 30, 2005

(54) Data processing apparatus and method

(75) Inventors: Chiwei Che, Taipei (TW); Uwe Helmut Jost, Haslemere (GB)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/999,923

(22) Filed: Dec. 1, 2004

(30) Foreign Application Priority Data
Dec. 23, 2003 (GB) 0329868.4

(51) Int. Cl. G06F 17/00

(52) U.S. Cl. 707/101

(57) ABSTRACT

Apparatus for processing a set of items of related user input data to facilitate the carrying out of a task has an interpreter (500) that is arranged to interpret a set of items of user input data to produce a corresponding set of interpretation results data including interpretation results data for each item of user input data. The interpreter (500) is arranged to constrain interpretation of an item of the set of user input data on the basis of constraint data related to the interpretation results data obtained for at least one other item of the set of user input data items. A controller (8) of the interpreter is arranged to detect an occurrence of an interpretation error in the interpretation results data for an item in the set of user input data items. The controller (8) is configured to cause, in the event that an interpretation error is detected for an item in the set of user input data items, the interpreter (500) to re-interpret at least one of the other items in the set of user input data items using modified constraint data to produce modified interpretation results data and to provide a control signal to facilitate the carrying out of a task in accordance with the set of modified interpretation results data.

This invention relates to a data processing apparatus and method, in particular a data processing apparatus and method for processing a set of items of related user input data to facilitate the carrying out of a task.

Apparatus for automatically conducting dialogues with users or customers are currently in use that enable, for example, telephone booking of tickets or completion of banking or bill paying transactions. These apparatus operate by prompting the user, for example by asking the user a sequence of questions, to elicit the information necessary to complete the transaction.

At each stage in the dialogue, the apparatus has to process or interpret the user's input. Thus, for example, in the case of spoken input, the apparatus has to conduct speech recognition processing on the user's input. The success of the dialogue with the user is dependent upon the apparatus being able to process the user's input quickly and accurately to ensure that a transaction is completed efficiently and in accordance with the user's wishes. Accordingly, the apparatus will normally ask the user to confirm that the interpretation of the user's input is correct before instructing action to be taken in accordance with the user's input. If the user does not confirm that the interpretation is correct, the apparatus determines that an error has arisen in processing the user's input and will ask the user to repeat their answers. This, necessarily, lengthens the dialogue with the user and inevitably increases the time required for the user to complete the required transaction so that the user views the system as less than desirable or efficient and is less likely to make use of it in future. Also, the user may well be frustrated or irritated by having to answer the same prompt more than once.

In one aspect, the present invention provides data processing apparatus for processing a set of items of related user input data to facilitate the carrying out of a task by constraining the grammars used for recognising user input data in accordance with the interpretation results for other user input data and enables the processing of user input data to be re-evaluated when an interpretation error is detected.

In one aspect, the present invention provides apparatus for conducting a dialogue with a user that enables efficient processing of responses to successive prompts by constraining the grammars used for recognising responses to successive prompts in accordance with the recognition results for responses to previous prompts and enables the processing of user responses to prompts to be re-evaluated when an interpretation error is detected which should reduce the need to repeat prompts to the user and may enable the length of the dialogue with the user to be reduced.

Dialogue apparatus embodying the invention enables the sequence of prompts to be presented in the order in which the user would expect to be asked for information yet still allows advantage to be taken of the fact that responses to certain prompts may be recognised more reliably than responses to other prompts. Thus, for example, serial numbers may be more reliably recognised than company names because serial numbers tend to conform to a standard format. A user, however, may naturally expect to be asked their company name before the serial number. Dialogue apparatus embodying the invention enables advantage to be taken of the fact that the serial numbers can be more accurately recognised than the company names while still enabling the prompts to be presented to the user in the order that seems most natural to users.

In an embodiment, the user communicates with the apparatus by use of speech and an automatic speech recognition engine is used to process input speech data. Automatic speech recognition engines cannot necessarily always detect the true end point of user's speech data particularly if the user pauses whilst speaking. Storing the digital speech data in the user response data files has the advantage that speech data separated by pauses can be concatenated for re-processing so that account can be taken of the possibility of an end point detection error.

The apparatus may be arranged to receive other forms of user input such as, for example, gesture input data, lip reading input data, handwriting input data or keyboard input data.

Embodiments of the present invention will now be described, by way of example, with reference to the accompanying drawings, in which:

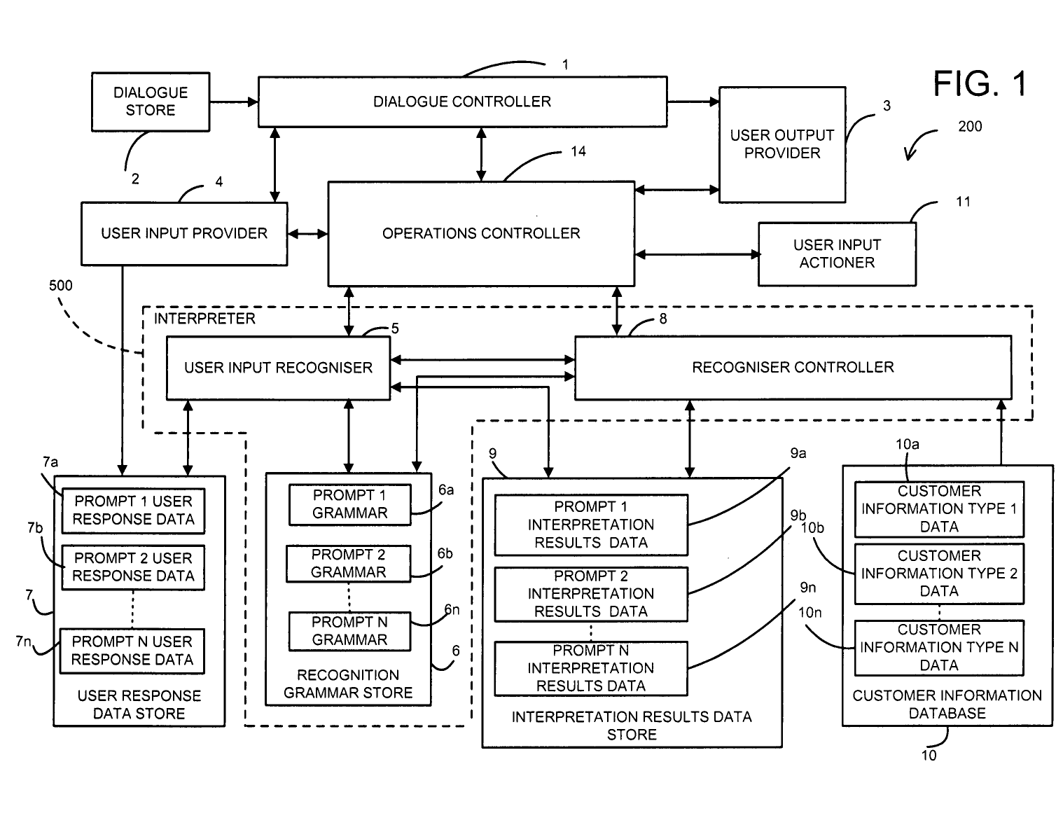

FIG. 1 shows a functional block diagram of dialogue apparatus embodying the invention for conducting a dialogue with a user;

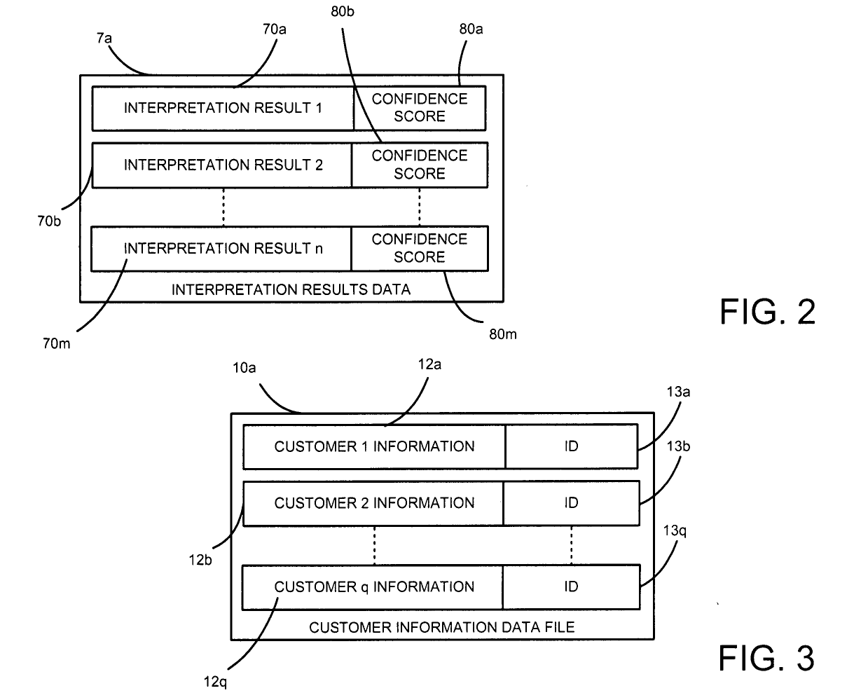

FIG. 2 shows very diagrammatically an interpretation results data file of an interpretation results data store shown in FIG. 1;

FIG. 3 shows very diagrammatically a customer information data file of a customer information database shown in FIG. 1;

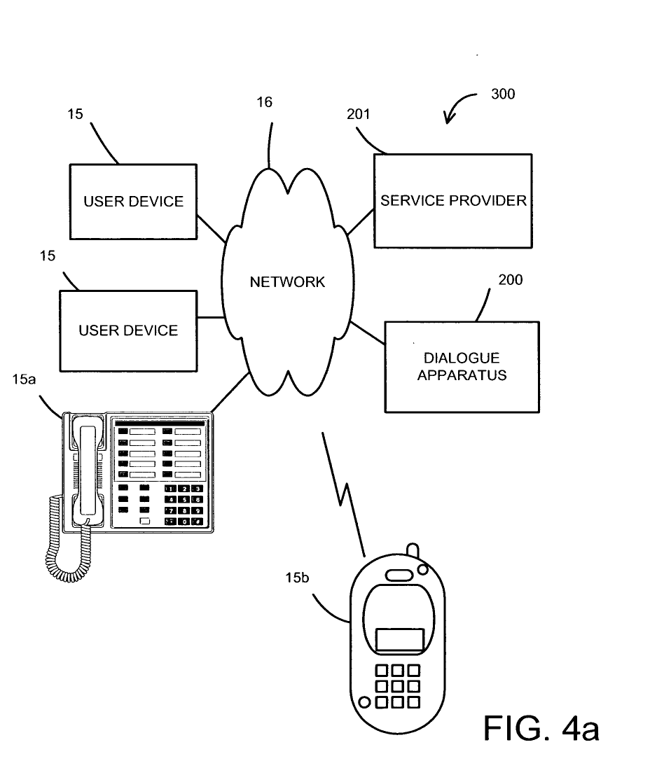

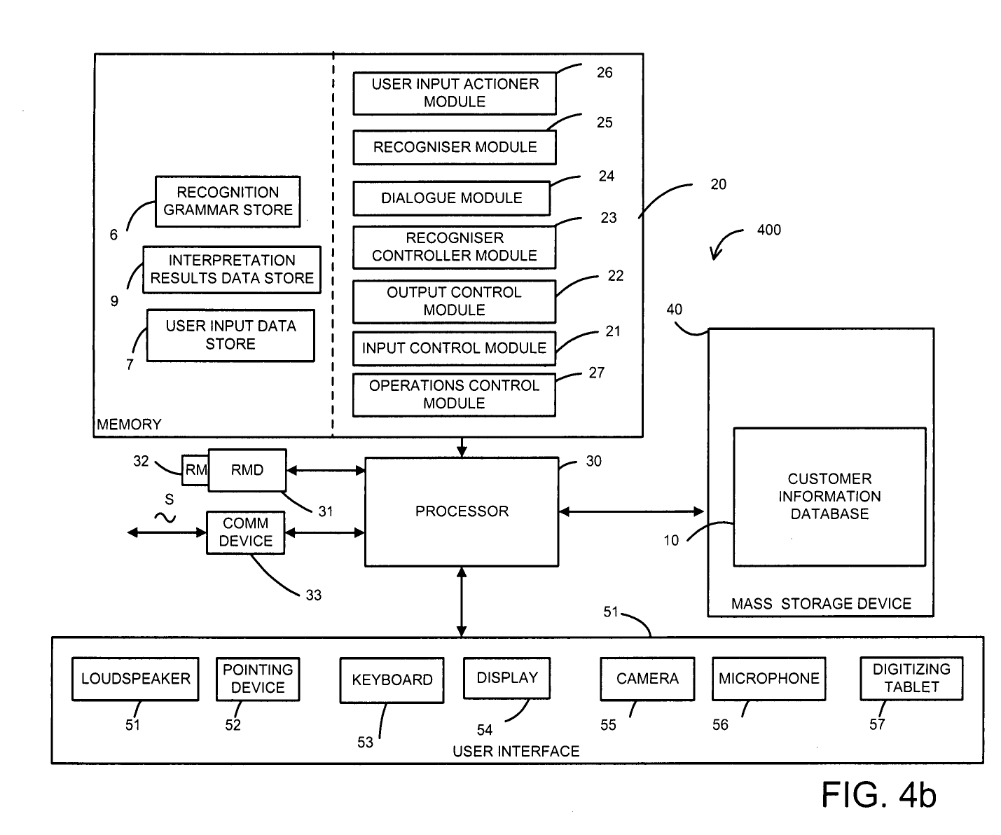

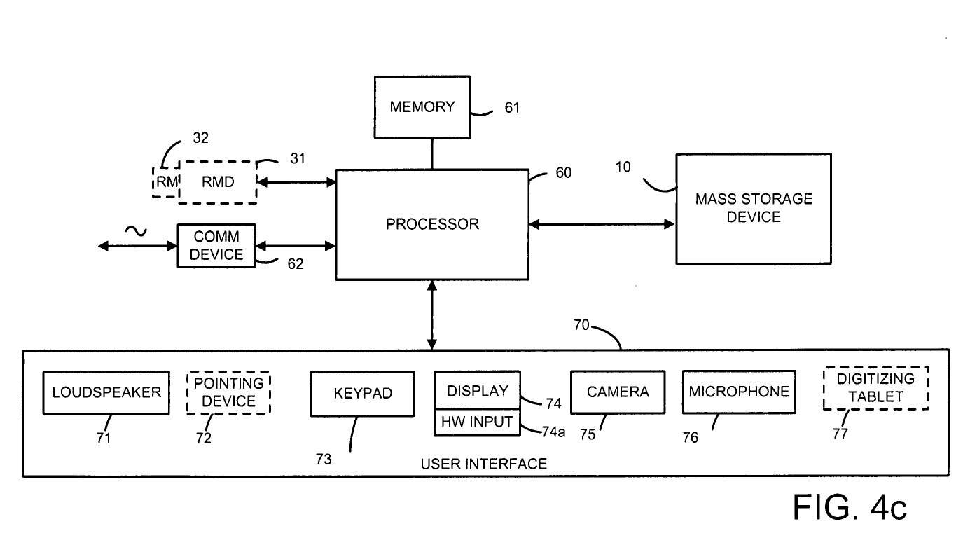

FIG. 4a shows a very diagrammatic representation of a communications system in which the apparatus shown in FIG. 1 is coupled to a number of user devices over a network;

FIG. 4b shows a functional block diagram of computing apparatus that may be configured by program instructions and data to provide the apparatus shown in FIG. 1;

FIG. 4c shows a functional block diagram of computing apparatus that may be configured by program instructions and data to provide one of the user devices shown in FIG. 4a;

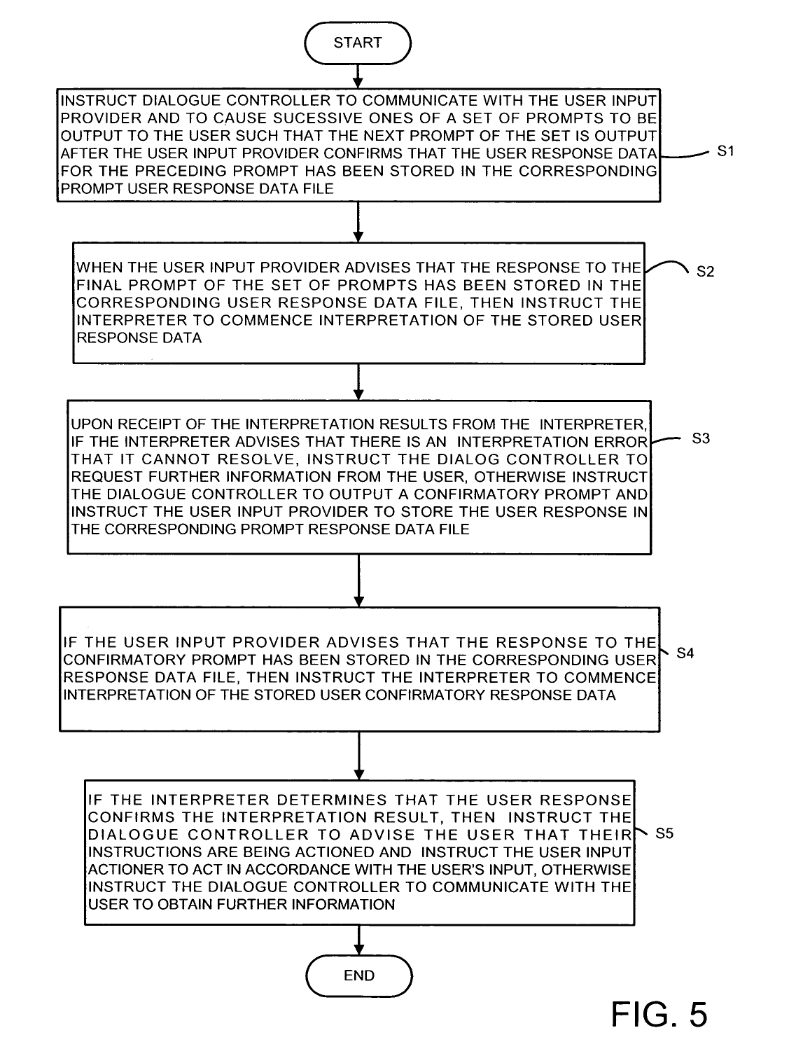

FIG. 5 shows a flow chart for illustrating operation of an operations controller of the dialogue apparatus shown in FIG. 1;

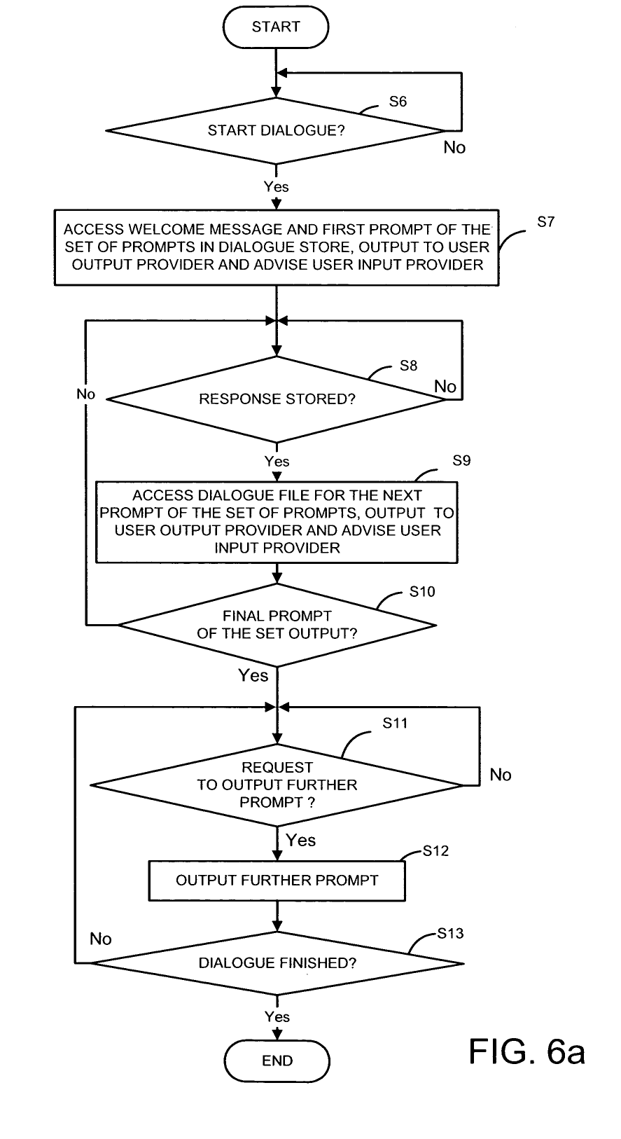

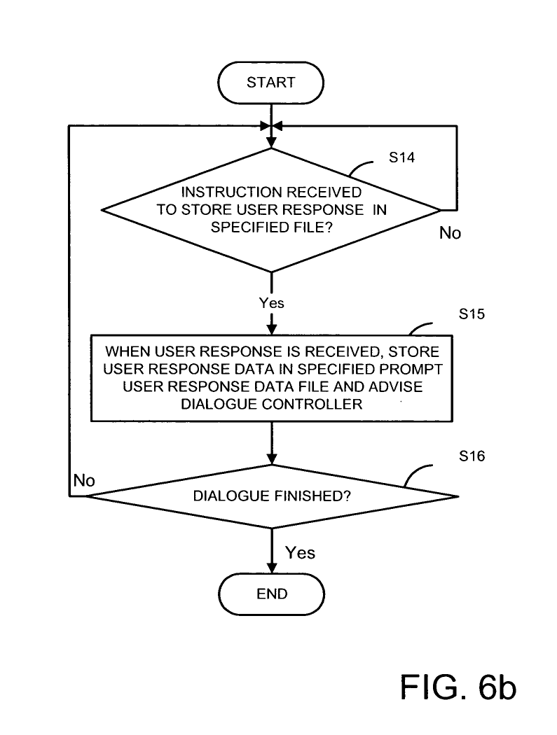

FIG. 6a shows a flow chart for illustrating operation of a dialogue controller of the dialogue apparatus shown in FIG. 1;

FIG. 6b shows a flowchart for illustrating operation of a user input provider of the dialogue apparatus shown in FIG. 1;

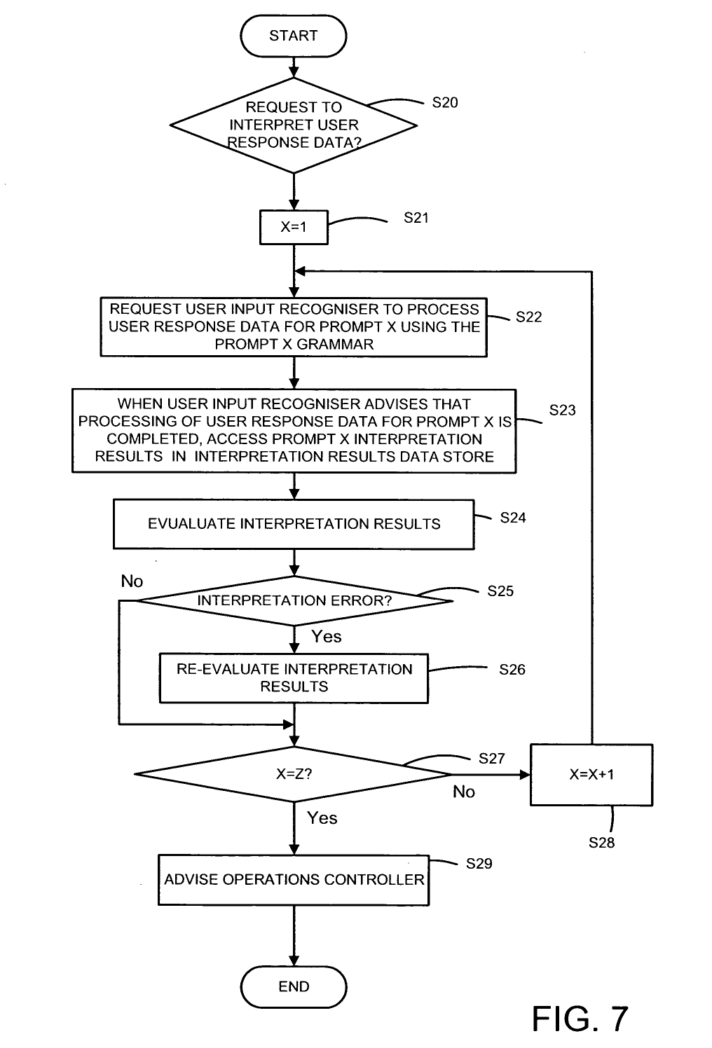

FIG. 7 shows a flow chart for illustrating operation of a recogniser controller of the apparatus shown in FIG. 1;

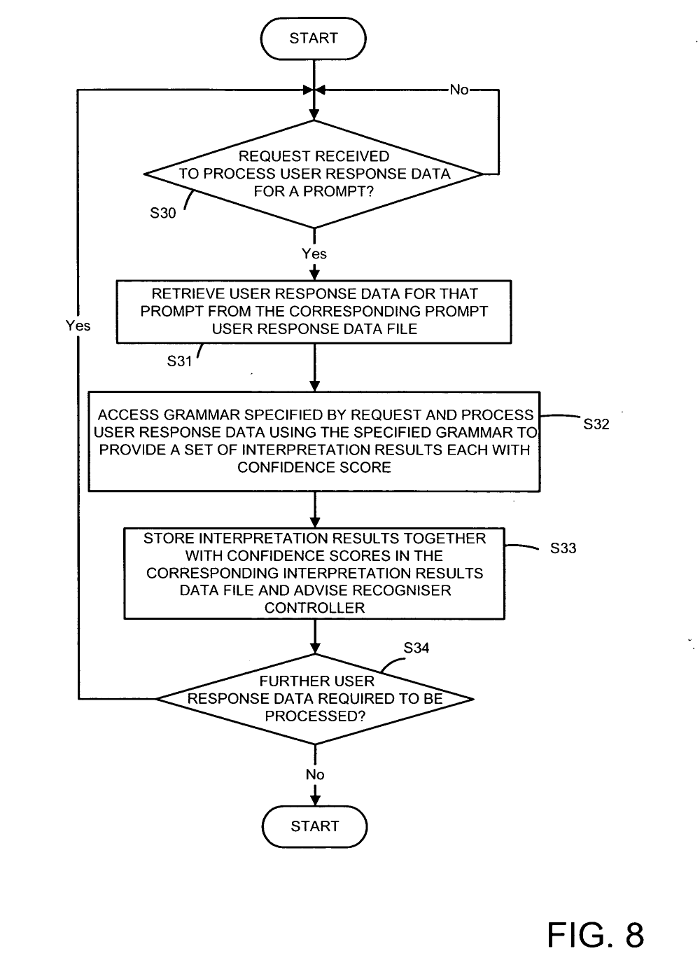

FIG. 8 shows a flow chart for illustrating operation of a user input recogniser shown in FIG. 1;

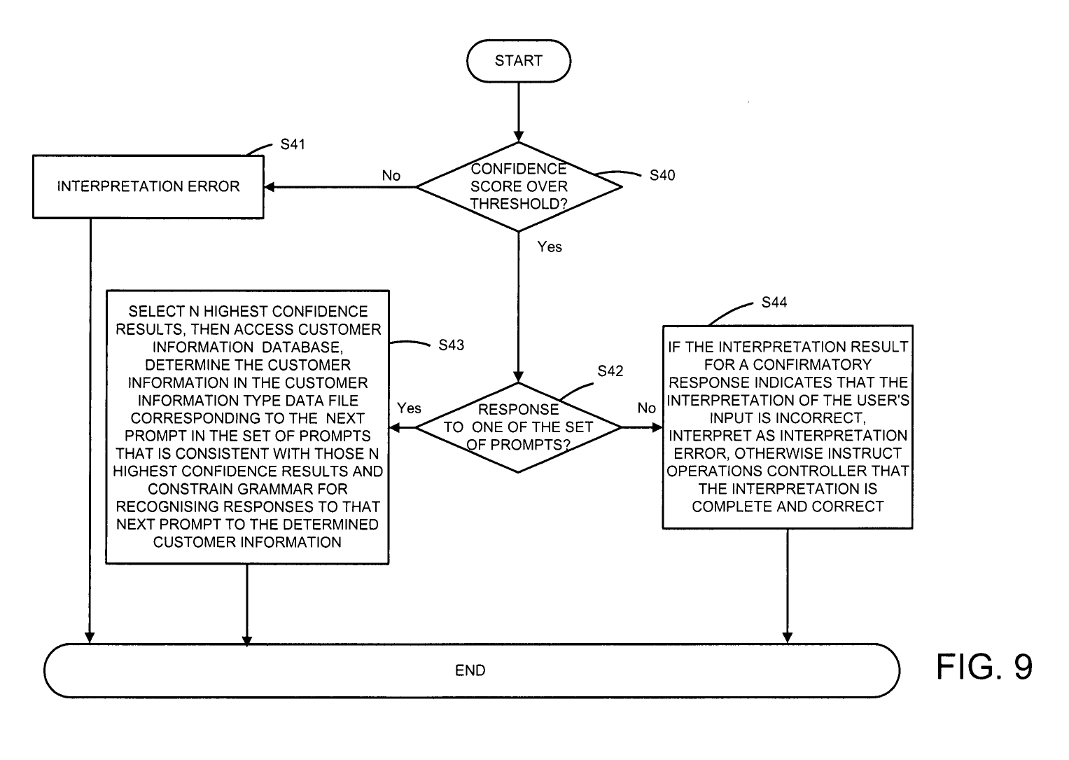

FIG. 9 shows a flow chart for illustrating one way of interpreting user input data;

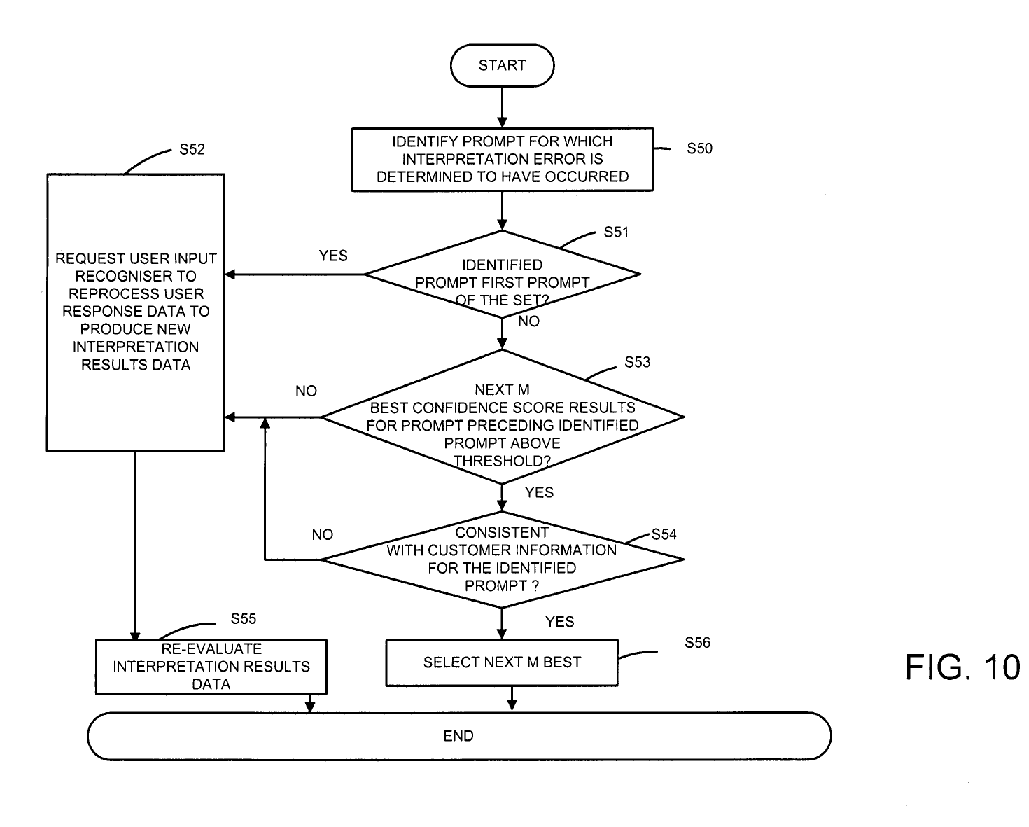

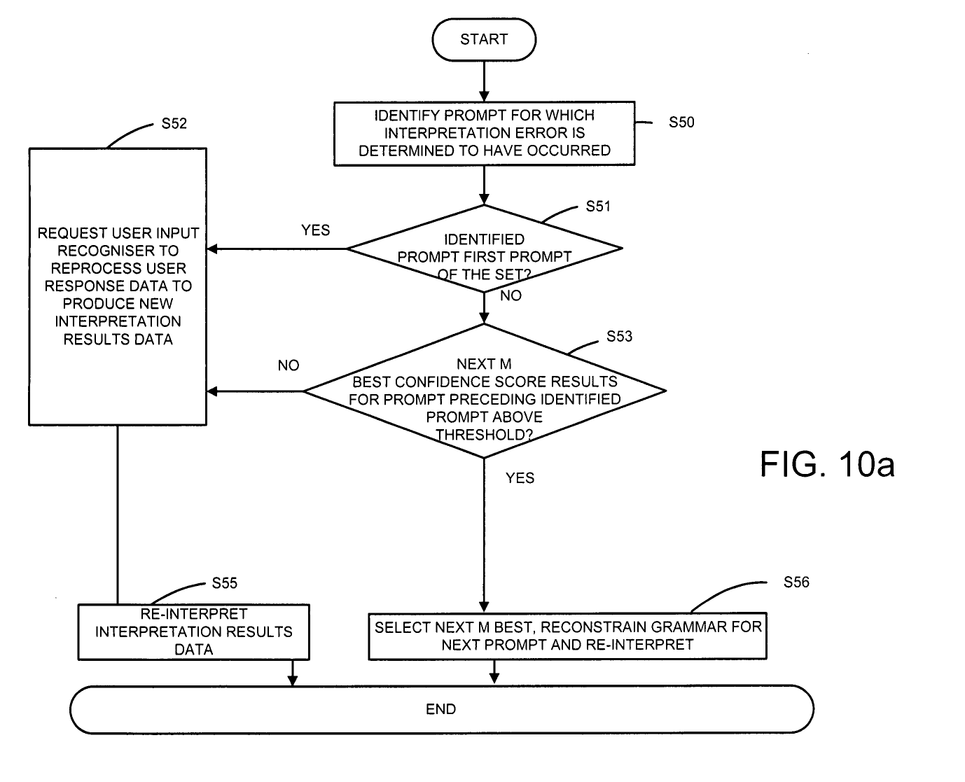

FIG. 10 shows a flow chart for illustrating one way in which a step of re-evaluating interpretation results may be conducted;

FIG. 10a shows a flow chart for illustrating another way in which a step of re-evaluating recognition may be conducted; and

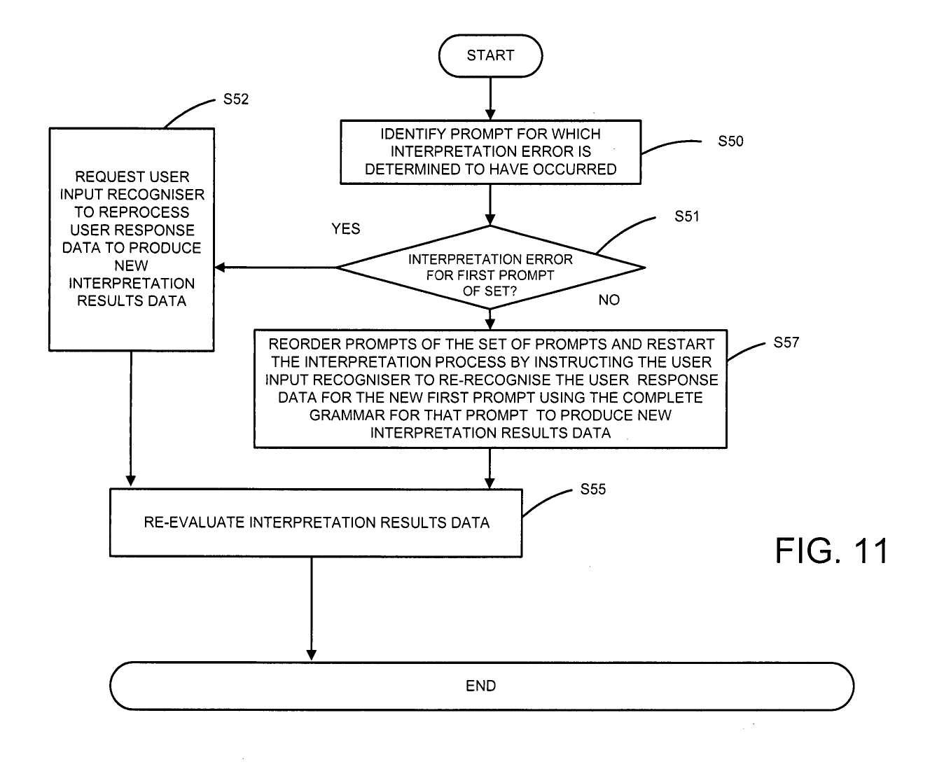

FIG. 11 shows a flow chart for illustrating another way in which a step of re-evaluating interpretation results may be conducted.

Referring now to FIG. 1, there is shown dialogue apparatus 200 for conducting a dialogue to enable the user to instruct the carrying out of a task or action. The action instructed by the user may be, for example, to issue instructions to another computing apparatus or another module of the same apparatus to carry out the user's wishes, for example to book and forward to the user tickets for a selected show, to complete a banking transaction or to log equipment usage in a database, depending upon the application for which the dialogue apparatus is being used.

The dialogue apparatus 200 comprises a dialogue controller 1 arranged to select prompts from a dialogue store 2 and to output these prompts to a user via a user output provider 3 and a user input provider 4 for receiving user responses to prompts supplied to the user via the user output provider 3. The prompts may be in the form of questions or may simply be statements or comments that indicate to the user the user input required.

The apparatus has an interpreter 500 for interpreting user input data provided by the user input provider 4 to provide interpretation results data. The interpreter 500 has a user input recogniser 5 for processing or recognising the user input data using grammars stored in a recognition grammar store 6 and a recogniser controller 8 for controlling operation of the user input recogniser 5.

A user input actioner 11 is provided for causing the action required by the user to be carried out once the dialogue with the user has been satisfactorily completed and the user has confirmed that their input has been interpreted correctly.

A user input or response data store 7 is provided for storing the user response data received by the user input provider 4 and an interpretation results data store 9 is provided to store interpretation results data provided by the interpreter 500.

A customer information database 10 is also provided which stores customer information data pertinent to the expected responses or answers to the prompts supplied by the dialogue controller 1.

In the example shown in FIG. 1, the user response data store 7 has respective user response data files 7a, 7b . . . 7n for prompts 1, 2 . . . N, respectively, that may be output to a user during a dialogue. Similarly, the interpretation results data store 9 has respective interpretation results data files for the prompts 1, 2 . . . N and the customer information database 10 respective customer information data files 10a, 10b . . . 10n for customer information data pertinent to the prompts 1, 2 . . . N. The recognition grammar 6 has, in this example, a respective grammar file 6a, 6b . . . 6n for use in recognition of responses to each of the prompts 1, 2 . . . N.

An operations controller 14 is provided to control overall operation of the apparatus and to coordinate the operation of the dialogue controller 1, the user input recogniser 5, the recogniser controller 8 and the user input actioner 11.

FIG. 2 shows very diagrammatically the structure of the interpretation results data file 7a. The interpretation results data file 7a has a respective interpretation result data entry field 70a, 70b . . . 70m for each interpretation result 1, 2 . . . M provided by the user input recogniser 5. Each interpretation result data entry field 70a, 70b . . . 70m is associated with a confidence score data entry field 80a, 80b . . . 80m for containing data indicating a confidence value for that recognition result determined by the user input recogniser 5. The interpretation results data files 7b . . . 7n will each have the same structure as the interpretation results data file 7a.

FIG. 3 shows the structure of the customer information type 1 file 10a. This data file has customer information type 1 data entry fields 12a, 12b . . . 12q for type 1 customer information for different customers 1, 2 . . . q. Each customer information type 1 data entry field 12a, 12b . . . 12q is associated with an ID data entry field 13a, 13b . . . 13q configured to contain data associating that customer information type 1 data entry field 12a, 12b . . . 12q with one or more customer information entry fields of the other customer information types. Examples of different customer information types are customer name data, customer address data such as post codes (zip codes), equipment serial number data. The ID data enables the different types of data to be associated with one another, that is a customer name can be associated with one or more addresses and one or more serial numbers. The other customer information files will have a similar structure to the customer information type 1 file 10a.

As illustrated very diagrammatically by FIG. 4a, the dialogue apparatus 200 is arranged to be incorporated in a communication system 300 that enables the dialogue apparatus 200 to communicate with a number of user devices 15 via a network 16. The network 16 may be a land-line or plain old telephone service (POTS) network or a cellular telecommunications network such as a GPRS telecommunications network, the Internet, an intranet or a local area or wide area network or a combination of these. As an illustration, FIG. 4a shows a network 16 having facilities for enabling both a user device 15a in the form of a fixed or land-line telephone and a user device 15b in the form of a cellular telephone (“cell phone” or mobile telephone) to communicate with the dialogue apparatus 200. As shown in FIG. 4a, the communications system 300 also includes a service provider 201 which administers operation of the communications system. The dialogue apparatus 200 may be administrated by the service provider or independently of the service provider.

FIG. 4b shows a functional block diagram of computing apparatus 400 storing program modules for configuring the computing apparatus to form the dialogue apparatus 200 shown in FIG. 1 while FIG. 4c shows a functional block diagram of one example of a user device 15 such as the cell phone 15b shown in FIG. 4a.

Referring firstly to FIG. 4b, the computing apparatus 400 comprises a processor 30 having a memory 20 comprising ROM and/or RAM storing program instruction modules for configuring the computing apparatus to form the dialogue apparatus 200 shown in FIG. 1. As shown, the program instruction modules include input and output control modules 21 and 22 for causing the computing apparatus to carry out the functions of the user input provider 4 and user output provider 3, a recogniser controller module 23, a dialogue module 24, a recogniser module 25 and a user input actioner module 26 for causing the computing apparatus to carry out the functions of the recogniser controller 8, dialogue controller 1, user input recogniser 5 and user input actioner 11, respectively, and a operations control module 27 for causing the computing apparatus to carry out the functions of the operations controller 14.

In this example, the memory 20 is also configured to contain the user input data store 7, the interpretation results data store 9 and the recognition grammar store 6.

The processor 30 is also coupled to a mass storage device 40 such as a hard disc drive which, in this example, contains the customer information database 10. It will, however, of course be appreciated that any one or more of the data stores and modules stored in the memory 20 may be stored in the mass storage device 40 with the program instruction modules being uploaded into the memory 20 for execution when required.

The processor 30 is also coupled to a removable medium device (RMD) 31 for receiving a removable medium (RM) 32 such as, for example, a floppy disc, a CDROM, CDR, CDRW, DVD and so on. In addition, the processor 30 is coupled to a communications (COMM) device 33 such as, for example, a MODEM or network card for enabling communication over the network 16. The processor 30 is also coupled to a user interface 50 which has at least a keyboard 53, a pointing device 52 such as a mouse and a display 54 such as a cathode ray tube (CRT) or liquid crystal display (LCD). The user interface may also have a loudspeaker 51, a microphone 56 and possibly also a camera 55 and a digitising tablet 57.

The computing apparatus 400 may be configured by program instructions and data to form the dialogue apparatus 200 shown in FIG. 1 by any one or more of the following:
1. program instructions and/or data pre-stored in at least one of the memory 20 and the mass storage device 40;
2. program instructions and/or data downloaded from a removable medium 32;
3. program instructions and/or data supplied as a signal S via the network 16 from another computing apparatus coupled to the network;
4. program instructions and/or data input by a user using one or more of the user input devices of the user interface 50.

FIG. 4c shows a functional block diagram of a user device 15, such as the cell phone 15b shown in FIG. 4a. This user device comprises a processor 60 associated with memory 61 in the form of ROM and/or RAM, a communications device (COMM DEVICE) 62 such as a MODEM or wireless communications card for enabling communication over the network 16 and a user interface 70 which, in this example, comprises a loudspeaker 71, a microphone 72, a keypad 73, a display 74 (generally an LCD display), and possibly also a camera 75. The display 74 may include a handwriting input area (HW INPUT) 74a for enabling the user to input data using a stylus.

The user input device 15 described with reference to FIG. 4c is a mobile telephone or cell phone. In this case, the user input data is speech data and the user input recogniser 5 comprises an automatic speech recognition engine which may be, for example, provided by commercially available automatic speech recognition software such as, for example, ViaVoice (trade mark) supplied by IBM. As other possibilities, the user device 15 may be, for example, a personal digital assistant (PDA) or personal computer or laptop having mobile or wireless communication facilities in which case the user device will generally also include a removable medium drive 31 for receiving a removable medium 32 (as shown in phantom lines) and the user interface 70 will generally include a pointing device 72 such as a mouse or touch pad and may also include a digitizing tablet 76 (as shown in phantom lines in FIG. 4c).

In operation of the system described with reference to FIGS. 1 to 4c above, a user wishing to use the service provided by the dialogue apparatus 200 first of all accesses the dialogue apparatus 200 via the network 16 in normal manner, for example by dialling the telephone number of the dialogue apparatus 200 where the network is a telecommunications network or inputting the Internet, intranet or network address where the network 16 is the Internet, an intranet or a local or wide area network, respectively.

Operation of the dialogue apparatus will now be described with the aid of FIGS. 5 to 11.

FIG. 5 shows a flowchart for illustrating the local control of the dialogue apparatus by the operations controller 14.

Thus, when the operations controller 14 determines from the user input provider 4 that a user device 15 (FIG. 4a) has established communication with the dialogue apparatus 200 via the network 16, then, at S1 in FIG. 5, the operations controller 14 instructs the dialogue controller 1 to communicate with the user input provider 4 and to cause successive ones of a set of prompts to be output to the user by the user output provider 3 such that the next prompt of the set is output after the user input provider 4 confirms to the dialogue controller 1 that the user response data for the preceding prompt has been stored in the corresponding prompt user response data file 7a, 7b . . . 7n of the user response data store 7.

When the user input provider 4 advises at S2 that the response to the final prompt of the set of prompts has been stored in the corresponding user response data file, then the dialogue controller 1 communicates this fact to the operations controller 14 which then instructs the interpreter 500 to commence recognition and interpretation of the stored user response data.

Upon receipt of the interpretation results from the recogniser controller 8 at S3, if the recogniser controller 8 advises that there is an interpretation error, for example an error in the recognition of the user response data (a recognition error) that the interpreter 500 cannot resolve, then the operations controller 14 instructs the dialogue controller 1 to request further information from the user, for example by outputting to the user a supplementary prompt or asking the user to repeat the response to one or more of the previous prompts. If, however, the recogniser controller 8 advises that there is no such recognition results error, then the operations controller 14 instructs the dialogue controller 1 to cause a confirmatory prompt to be output to the user via the user output provider 3 and instructs the user input provider 5 to store the user response in the corresponding prompt response data file of the user response data store 7.

When the user input provider 4 advises that the response to the confirmatory prompt has been stored in the corresponding user response data file at S4, then the operations controller 14 instructs the interpreter 500 to commence recognition and interpretation of the stored user confirmatory response data at S4.

If, at S5, the recogniser controller 8 advises the operations controller 14 that the user response confirms the interpretation result, then the operations controller 14 instructs the dialogue controller 1 to advise the user that their instructions are being actioned and instructs the user input actioner 11 to act in accordance with the user input. As set out above, the action instructed by the user may be, for example, to issue instructions to another computing apparatus or another module of the same apparatus to carry out the user's wishes, for example to book and forward to the user tickets for a selected show, to complete a banking transaction or to log equipment usage in a database, depending upon the application for which the dialogue apparatus is being used.

If, however, the recogniser controller 8 determines that the user has not confirmed the correctness of the interpretation result, then the operations controller instructs the dialogue controller 1 to communicate with the user via the user output provider 3 to obtain further information, for example the dialogue controller 1 may ask the user to repeat the response to one or more of the set of prompts.

FIG. 6a shows a flow chart for illustrating operation of the dialogue controller 1.

Thus, when the dialogue controller 1 receives from the operations controller 14 at S6 instructions to commence the dialogue, the dialogue controller 1, at S7 in FIG. 6, accesses the dialogue file for a welcome message and the first of a set of prompts to be asked in the dialogue store 2, indicates to the user input provider 4 the particular prompt user response data file in which the next user response data is to be stored, and causes the user output provider 3 to output to the user device 15 via the network 16 data representing the welcome message and the first prompt prompting the user to supply user input.

The dialogue controller 1 then waits at S8 for confirmation from the user input provider 4 that a user response to the first prompt has been received and stored in the user response data store 7. When this confirmation is received, then at S9, the dialogue controller accesses the dialogue store and selects the dialogue file for the next prompt of the set of prompts, indicates to the user input provider 4 the particular prompt user response data file in which the next user response data is to be stored, and then causes the user output provider 3 to output that prompt to the user device 15 via the network 16.

At S10 the dialogue controller checks whether the final prompt of the set of prompts has been asked of the user and, if not, repeats steps S8 to S10 until the last prompt of the set has been asked.

Then, at S11, the dialogue controller waits for a request from the operations controller 14 to output a further prompt (which as explained above with reference to S3 in FIG. 5 may be a confirmatory prompt or a request for further information). When such a request is received, then the dialogue controller accesses, at S12, the relevant dialogue file in the dialogue store 2, indicates to the user input provider 4 the particular prompt user response data file in which the next user response data is to be stored, and causes the corresponding prompt to be output to the user via the user output provider 3. The dialogue controller then checks at S13, whether the operations controller 14 has confirmed that the dialogue has been completed or finished and if the answer is no repeat steps S11 to S13.

FIG. 6b shows a flowchart illustrating the operations carried out by the user input provider 4. Thus, at S14, the user input provider 4 waits for instructions from the dialogue controller 1 to store the next received user response in a specified file, that is the file corresponding to the prompt last asked of the user. Then, when, at S15, the user input provider 4 receives user response data, then the user input provider 4 stores that user response data in the specified prompt user response data file and advises the dialogue controller 1 that the data has been stored so that the dialogue controller can proceed to output the next prompt of the set of prompts to the user output provider 3.

The user input provider 4 then checks at S16 to determine whether an instruction has been received from the operations controller 14 that the dialogue is finished and, if not, repeats steps S14 and S15.

Operation of the interpreter 500 will now be described with the aid of FIGS. 7 and 8 which illustrate the operations carried out by the recogniser controller 8 and the user input recogniser 5, respectively, in response to a request to recognise and interpret stored user response data from the operations controller 14.

Referring firstly to FIG. 7, when, at S20, the recogniser controller 8 receives a request from the operations controller 14 to interpret user response data then, at S21, a count x is set to 1 and at S22, the recogniser controller 8 requests the user input recogniser 5 to process the user response data for prompt x using the prompt x grammar in the recognition grammar store 6.

When, at S23, the user input recogniser 5 advises that the processing of the user response data for prompt x is completed, then the recogniser controller 8 accesses the prompt x interpretation results in the interpretation results data store 9 and at S24 processes the interpretation results as will be described in greater detail below with reference to FIG. 9. If, as a result, the recogniser controller 8 determines that an interpretation error has occurred at S25 then, at S26, the recogniser controller 8 causes the interpretation results to be re-evaluated as will be described in greater detail below with reference to FIGS. 10 and 11.

After re-evaluation of the interpretation results, or if the answer at S25 is no, then the recogniser controller 8 checks to see whether x=z, that is whether the interpretation results for the number of prompts identified by the operations controller 14 has been processed and, if not, at S28 sets x=x+1 and repeats steps S22 to S27 until the answer at S27 is yes. Thus, when the operations controller 14 requests recognition and interpretation of the stored user response data at S2 in FIG. 5, Z will be set equal to the number of prompts in the set of prompts so that S22 to S27 are repeated for each of those prompts whereas when the operations controller requests recognition and interpretation of stored user confirmatory response data Z will be set to 1 so that steps S22 to S27 are repeated only once.

When the answer at S27 is yes, then the recogniser controller 8 advises the operations controller 14 of the results of the recognition and interpretation process so that the operations controller 14 can then carry out the operations of S3 in FIG. 5 if the recognition and interpretation was of the response data for the set of prompts or the operations set out in S5 of FIG. 5 when the response data was a response to a confirmatory prompt.

FIG. 8 shows a flow chart for illustrating operation of the user input recogniser 5 shown in FIG. 1.

Thus, at S30, the user input recogniser 5 waits for a request to process received user response data for a prompt.

When a request is received to process received user response data, then the user input recogniser 5 retrieves the user input data identified in the request from the corresponding prompt user response data file at S31.

Then, at S32, the user input recogniser 5 accesses the grammar specified in the request and processes the user response data using that grammar to provide a set of interpretation results in which each interpretation result is associated with a confidence score indicating the reliability of the interpretation result, that is the likeliness that that interpretation result represents what the user actually input. For example, where the user's response to prompt 1 is expected, the user input recogniser 5 is instructed to use the prompt 1 grammar 6a to process user input received from the user input provider 4.

At S33, the user input recogniser 5 stores the interpretation results together with the confidence scores in the corresponding file of the interpretation results data store 9 and then, at S34, checks for instructions regarding further user response data to be processed. The user input recogniser 5 repeats steps S30 to S34 until the answer at S34 is no, that is until the operations controller 4 advises that the dialogue has been completed.

FIG. 9 shows a flow chart illustrating the operation carried out by the recogniser controller 8 at S24 in FIG. 7.

Thus, at S40, the recogniser controller 8 checks to see whether the confidence scores of any of the interpretation results are above a predetermined minimum threshold. If the answer is no then the recogniser controller determines that an interpretation error has occurred at S41.

If, however, the answer at S40 is yes, then at S42, the recogniser controller 8 determines whether the interpretation results represent a response to one of the set of prompts and, if so, proceeds to step S43. If, however, the recogniser controller 8 determines that the interpretation results do not represent a response to one of the sets of prompts (that is the interpretation results represent a response to a confirmatory prompt or a further prompt), then the recogniser controller proceeds to step S44.

Assuming that the response is the response to one of a set of prompts, then at S43, the recogniser controller 8 selects the N highest confidence interpretation results for the current prompt, then accesses the customer information database 10, determines the customer information type data file corresponding to the next prompt in the set of prompts and identifies in that data file the data that is consistent with those N highest confidence results and then constrains the grammar for the next prompt in the recognition grammar store 6 so that, when the user input recogniser 5 processes the user response data for that next prompt, the user input recogniser 5 can only recognise customer information of the type corresponding to that prompt that is consistent with the N highest confidence results to the previous prompts.

Thus, to take an example, if the interpretation results are for the first prompt of the set of prompts, then the recogniser controller 8 will identify from the confidence scores stored in the interpretation results data file (see FIG. 2), the N highest confidence interpretation results and will then identify the customer information in the customer information type 1 data file corresponding to those N highest interpretation results. Then, by using the ID fields (see FIG. 3), the recogniser controller 8 will determine the data entries in the customer information type 2 type data file having the same IDs as the N highest confidence results for the first prompt. The recogniser controller 8 then constrains the prompt 2 grammar so that, in addition to common general words that are not specific to customer information, the grammar can only recognise customer information of type 2 that the recogniser controller 8 has determined is consistent with the N highest confidence results for the first prompt. This procedure is then repeated for any further prompts so that the prompt 3 grammar is constrained to customer information consistent with the N highest confidence results for prompt 2 and so on.

The procedure of constraining the grammar for successive prompts significantly reduces the number of possibilities that the user input recogniser 5 has to check when processing user response data and thus has the advantage of speeding up the interpretation process. However, if the user input recogniser 5 incorrectly interprets user response data for one prompt, then the grammars for successive prompts will be incorrectly constrained and accordingly interpretation errors will be propagated and probably made worse. The recogniser controller addresses these problems by checking for interpretation errors at S25 and re-evaluating interpretation results at S26 as will be described below in the event of a detection of an interpretation error.

If the answer at S42 is no, then the recogniser controller 8 assumes that the prompt was a confirmatory prompt and determines that an interpretation error has occurred if the interpretation results for the confirmatory prompt indicate that the interpretation of the user's input to the set of prompts was incorrect. Otherwise the recogniser controller 8 instructs the operations controller 14 that the interpretation is complete and correct.

FIG. 10 shows one way in which the recogniser controller 8 may cause interpretation results to be re-evaluated in the event of an interpretation error being detected.

Thus, at S50 in FIG. 10, the recogniser controller 8 identifies the prompt which prompted the response at which the interpretation error was determined to have occurred. Thus, the recogniser controller 8 identifies which one of the set of prompts resulted in an interpretation error or, in the case of an interpretation error arising from a confirmatory prompt, a prompt of the set of prompts related to the confirmation operation.

Then, at S51, the recognition results determiner 8 determines whether the identified prompt is the first prompt of the set. If the answer is yes, then the interpretation error will have occurred because none of the interpretation results had a sufficiently high confidence score (this may have arisen because of, for example, data corruption or a software or hardware fault during the recognition process). Accordingly, at S52, the recogniser controller 8 requests the user input recogniser 5 to re-process the user response data to produce new interpretation results and then, at S55, the recogniser controller 8 evaluates the new interpretation results data.

If, however, the answer at S51 is no, then at S53, the recognition controller 8 assumes that the constraining of the grammar to data consistent with the N best confidence score results for the previous prompt meant that the user input recogniser 5 was not capable of producing recognition results with sufficiently high confidence scores. Accordingly, at S53, the recogniser controller 8 determines whether the next M best confidence score results for the prompt preceding the identified prompt are above the determined confidence score threshold. If the answer at S53 is no, then the recogniser controller 8 assumes that the interpretation error arose because of data corruption or a software or hardware problem during the recognition process and, at S52, requests the user input recogniser to re-process the user response data for that preceding prompt, to select the new N best results and then re-process the response data for the identified prompt using the grammar constrained in accordance with the new N best results for the re-processed response data for the preceding prompt.

If, however, the answer at S53 is yes, then at S54 the recogniser controller 8 checks the customer information data type files for the two prompts to determine whether any of the next M best confidence score results for the preceding prompt are consistent with the interpretation results for the identified prompt. If the answer is no, then the recogniser controller 8 requests the user input recogniser 5 to re-process the user response data for the preceding prompt at S52. If, however, the answer is yes then the recogniser controller 8 selects those next M best interpretation results at S56.

Thus, in the event an interpretation error occurs in the response to other than the first prompt, the recogniser controller back tracks to the interpretation results for the previous prompt, checks the next M best interpretation results to determine whether any of those are consistent with the interpretation results for the identified prompt and, if so, selects those next M best results. Accordingly, the recogniser controller 8 can avoid propagation of interpretation errors through the recognition of the answers to successive prompts by back tracking and modifying its evaluation of the interpretation results for a proceeding prompt in the event that an interpretation error is detected.

FIG. 10a shows another way in which the recogniser controller 8 may cause interpretation results to be re-interpreted in the event of an interpretation error being detected.

FIG. 10a differs from FIG. 10 in that steps S54 and S56 are replaced by step S56a. Thus, in this case, when the answer at S53 is yes, the recogniser controller 8 selects the next M best results, reconstrains the grammar to be used for the next prompt in accordance with those M best results, requests the user input recogniser 5 to reprocess the user input data for that next prompt and, when this has been done, re-evaluates the interpretation results for that next prompt. Thus is this case, account is taken of the fact that selecting the M best results rather than the N best results may affect the way in which the grammar to be used for recognising the user input data for the next prompt should be constrained.

FIG. 11 shows another way in which the recogniser controller 8 may cause interpretation results to be re-interpreted in the event of an interpretation error being detected.

In this case, the recogniser controller 8 carries out steps S50, 51, 52 and 55 as described above. However, if the answer at S51 is no, that is the interpretation error occurs in the prompt other than the first prompt of the set of prompts, then at S57, the recogniser controller 8 re-orders the prompts of the set of prompts and re-starts the recognition and interpretation process by instructing the user input recogniser 5 to re-recognise the user response data for the new first prompt using the complete, that is the unconstrained, grammar for that prompt to produce new interpretation results data for that prompt and then proceeds to re-interpret the interpretation results data at S55 by carrying out the steps described above with reference to FIG. 9.

Thus, in the example shown in FIG. 11, if an interpretation error occurs, the recogniser controller 8 assumes that better recognition results may be achieved if the recognition and interpretation process is started from the response to another one of the set of prompts and thus initiates re-recognition and interpretation of the response data with the prompts re-ordered.

If the recogniser controller 8 determines that no interpretation error has occurred or has re-evaluated the recognition results to remove an interpretation error, then the recogniser controller selects the highest confidence score recognition results for the set of prompts as being the correct recognition of the user's input and requests the operations controller at S29 in FIG. 7 to instruct the dialogue controller to cause the user output provider 3 to output a prompt requesting the use the confirm that this is actually what the user input.

If, however, the recogniser controller 8 determines that there is an interpretation error that the dialog apparatus cannot resolve, then at S29 in FIG. 7, the recogniser controller 8 advises the operation controller 14 to request the dialogue controller 1 to output a further prompt to the user via the user output provider 3 requesting further information in an attempt to resolve the interpretation error, for example the further prompt may request the user to repeat their answer to the prompt preceding the prompt for which the interpretation error was detected.

As will be appreciated from the above, the fact that the received user input data for each prompt is stored in the user response data store 7 and the interpretation results data for each prompt is stored in the interpretation results data store 9 enables the recognition results to be re-evaluated when an interpretation error is detected either by the recogniser controller 8 re-assessing the recognition results and/or causing a supplementary prompt to be asked or, where the results of that re-assessment are not reliable or the confidence scores of the remaining recognition results are not sufficiently high, requesting the user input recogniser 5 to re-process the received user input data. This means that, when the recogniser controller 8 identifies that an interpretation error has occurred, it is not necessary for the user to be asked to repeat the response to a prompt. This should avoid a lengthy dialogue with the user or at least avoid the user becoming frustrated or dissatisfied with the system because they are asked one or more times to repeat their answer to a prompt.

An example of a specific implementation of the dialogue apparatus will now be described where the dialogue apparatus is being used to enable a customer to use a telephone interface to log with a photocopier provider the number of pages copied in a current charging period.

In this example, the dialogue apparatus 200 needs to ascertain the name of the customer and the serial number of the photocopier for which the numbered pages copied is to be logged and the number of pages to be logged.

In this case, there are three customer information type data files. The customer information type 1 data file 10a stores in the customer information fields 12a, 12b . . . 12q the names of the customers who have the facility to use the telephone logging service while the customer information type 2 data file 10b stores the serial numbers of the photocopiers provided by the photocopier provider and the customer information type 3 data file stores address data, typically a postcode (zip code), that may be used as a confirmatory prompt. In this case, the ID data stored in the ID fields of these customer information type data files is an identity code identifying the customer so that, in the customer information type 2 data file, each serial number is associated with an identity code identifying the corresponding customer information type 1 data entry.

In this example, when the operations controller 14 determines that a user has logged onto the dialogue apparatus and the operations controller 14 instructs (S1 in FIG. 5) the dialogue controller 1 to commence the dialogue, the dialogue controller 1 causes (S7 in FIG. 6a) the user output provider 3 to output to the user a welcome message such as:
“Welcome to the Canon telephone photocopier charge logging service”
followed by the first prompt from the dialogue store 2 which prompts the user to input their company name. For example this prompt may be:
“Please tell me your company name”.

In this example, the customer answers by saying:
“Royal Bank of Westland”.

This user speech data is supplied by the network 16 to the user input provider 4 which stores the speech data in digital form in the prompt 1 user response data file 7a of store 7 (S15 in FIG. 6a).

Then (S8 in FIG. 6a) the dialogue controller 1 causes the user output provider 3 to output the next of the set of two prompts to the user, in this example:
“Please tell me your serial number”
   and advises the input provider 4 to store any received speech data in the prompt to user response data file 7b.

When the user input provider 4 receives the user response then (S15 in FIG. 6b) the user input provider 4 stores that response in the prompt to response data file 7b.

In this example, the user responds by saying:
“QFE10515”

As, in this example, this is the last of the set of prompts, the operations controller 14 (S2 in FIG. 5) then instructs the user input recogniser 5 and recogniser controller 8 to commence recognition and interpretation of the stored speech data.

The recogniser controller 8 then (S22 in FIG. 7) requests the user input recogniser 5 to process the speech data stored in the prompt 1 response data file 7a using the prompt 1 grammar 6a. The user input recogniser 5 then carries out steps S31 and S32 in FIG. 8 and then stores (S33 in FIG. 8) the interpretation results together with confidence scores in the prompt 1 interpretation results data file 9a. In this example, the user input recogniser 5 provides the interpretation results:

| INTERPRETATION RESULT | CONFIDENCE SCORE |
|---|---|
| Royal Bank of Westland | 80% |
| Bank of Westland | 70% |
| Royal Bank of Eastland | 40% |
| Bank of Eastland | 30% |

Then, at S24 in FIG. 7, the recogniser controller 8 evaluates the interpretation results for prompt 1 as described above with reference to FIG. 9. Thus, at S40, FIG. 9, the recogniser controller 8 first checks to see whether any of the confidence scores are over a threshold, in this example 50% and, as the answer is yes, proceeds to check whether a response is a response to one of the set of prompts (rather than a confirmatory or further prompt). As, in this case, the answer is yes, then at S43 the recogniser controller 8 selects the N highest confidence results, in this case the case the two interpretation results having a confidence score over 50%, accesses the customer information database and determines from the IDs associated with the customer names the serial numbers in the customer information type 2 data file 10b that are consistent with the company names Royal Bank of Westland and Bank of Westland.

The following table 1 shows examples of the serial numbers that the customer information type 2 data file 10b may contain for each of the four company names listed above.

TABLE 1

| Royal Bank | Bank of | Royal Bank | Bank of |
|---|---|---|---|
| of Westland | Westland | of Eastland | Eastland |
| QFE 10514 | QFE 10614 | QFE 20724 | QFE 20824 |
| QFE 10515 | QFE 10615 | QFE 20725 | QFE 20825 |
| QFE 10516 | QFE 10616 | QFE 20726 | QFE 20826 |
| QFE 10517 | QFE 10617 | QFE 20727 | QFE 20827 |
| QFE 10518 | QFE 10618 | QFE 20728 | QFE 20828 |
| QFE 10519 | QFE 10619 | QFE 20729 | QFE 20829 |
| QFE 10520 | QFE 10620 | QFE 20730 | QFE 20830 |

Thus, in this example, the recogniser controller 8 constrains the prompt 2 grammar to serial numbers having a format QFE followed by a five digit number by which the first and second digits are a one and a zero.

In this example, the user's response to the second prompt was:
“QFE 10515”

However, the user input recogniser 5 provides the following interpretation results in order of confidence score
1 QFE 10615 90%
2 QFE 10515 60%
3 QFE 10515 60%
4 QFE 10616 50%

The recogniser controller 8 then determines the confidence scores for the Nth highest (that is the first and second in this case) interpretation results for the response to the first prompt and the Nth highest (that is the first and second in this case) interpretation results for the response to the second prompt and, as a consequence, determines that the most likely interpretation of the user's input that is consistent with the customer information stored in the customer information type 1 and type 2 data files 10a and 10b is that the user responded by saying:
“Bank of Westland” and “QFE10615”

The recogniser controller 8 has thus established that there is a combination of interpretation results having sufficiently high confidence scores that is not inconsistent with the data in the customer information database and advises the operations controller accordingly (S29 in FIG. 7).

The operations controller 14 then instructs the dialogue controller 1 to cause the user output provider 3 to output a confirmatory prompt and I instructs the user input provider to store the corresponding response in the corresponding confirmatory prompt response data file in the user response data store (S3 in FIG. 5). The confirmatory prompt may be:
“Are you calling from the Bank of Westland in connection with serial number QFE 10615?”

When the user input provider 5 advises that the response to the confirmatory prompt has been stored, then the operations controller 14 instructs the user input recogniser 5 and the recogniser controller 8 to commence recognition and interpretation of the stored user confirmatory response data instructing the user input recogniser 5 to use a confirmatory prompt grammar that expects user input including words such as “yes” or “no” or “that is correct” or “that is incorrect”.

In this example, the user's input has been interpreted incorrectly because the user actually said “Royal bank of Westland” and “QFE 10515”.

Accordingly, the user responds by saying a phrase which includes the word “no” so that, when the recogniser controller 8 accesses the confirmatory prompt interpretation results data file, the recogniser controller 8 determines at S44 in FIG. 9 that an interpretation error has occurred. In this example, the recogniser controller is configured to re-evaluate the interpretation results in a manner described above with reference to FIG. 11 by (because the recognition error arose after the response to the second prompt had been subject to recognition and interpretation) re-ordering the prompts of the set of prompts so that the user response data for the second prompt, that is the serial number, is processed and interpreted first, thereby avoiding the knock-on effect of the interpretation error resulting from the fact that the user input recogniser 5 incorrectly recognised the user input “Royal Bank of Westland” as “Bank of Westland”.

If the user does not confirm the interpretation result, then the operations controller 1 may instruct the dialogue controller to output a supplementary prompt that seeks an answer not previously given by the user so that the user does not feel that he is having to repeat himself. Thus, in this example, the supplementary prompt prompts the user for their postcode, for example the supplementary prompt may be:
“please tell me your postcode”

Once the user input provider advises that the response to the further or supplementary prompt has been stored in the corresponding user response data file, then the operations controller will instruct the user input recogniser and the recogniser controller to commence recognition and interpretation of the stored user to confirm the response data using a postcode grammar in the recognition grammar store which expects a combination of alpha-numeric characters in a postcode format. The recogniser controller will then, in accordance with S57 in FIG. 11 re-order the set of prompts and process the postcode interpretation results data first.

As an alternative to using the re-evaluation procedure as described with reference to FIG. 11, the re-evaluation procedure described with reference to FIG. 10 may be used so that the lower confidence level combinations of the interpretation results are tested for consistency with the postcode interpretation results data.

In another embodiment, the postcode prompt may be included in the set of prompts that the user is asked before an attempt is made to confirm the user's input and, when an interpretation error is determined to have arisen, one or other of the re-evaluation procedures described with reference to FIG. 10 and FIG. 11 may be used. As another possibility, the dialogue apparatus may be configured to use a re-evaluation process as described with reference to FIG. 10 and, if the user does not confirm the results of that re-evaluation process, then to try the re-evaluation process shown in FIG. 11. If neither of these re-evaluation processes produces a confirmatory response from the user, then the dialogue apparatus may be configured to cause the user to be requested to repeat their responses to one or more to the set of prompts.

Following receipt of the user's confirmation that the company name and serial number are correct, the operations controller 14 causes the dialogue controller 1 to prompt the user to input the charging log data, that is the number of pages copied. The dialogue controller 1 also instructs the user input recogniser 5 to process any subsequently received speech data using a number only grammar and, when the user input recogniser 5 has interpreted the received speech data, the recogniser controller 8 communicates with the operations controller 14 which causes the dialogue controller 1 to output a prompt requesting confirmation of the number of copies, for example:
“Please confirm that the number of copies is 226”.
   and instructs the user input recogniser 5 to use the confirmatory prompt grammar for processing the next received speech data.

If the user then responds by saying yes, the recogniser controller 8 communicates with the operations controller 14 which causes the user input actioner 11 to access the customer's account to insert the number of copies taken in the current charging period.

As described above, the user inputs the number of copies verbally. As another possibility, the user may use the DTMF (dual tone multi frequency) tone dialling codes associated with the key pad of the user's telephone to input the number of copies and the operations controller 14 may be arranged to pass such data directly from the user input provider 4 to the user input actioner 11 together with the company name and serial number identified in the interpretation results data store 9 as being the correct interpretation of the user's input.

In the above described examples, the recogniser controller 8 constrains the grammar used for recognition of the second and subsequent prompts to data that, in accordance with the information stored in the customer information database 10, is consistent with the interpretation results for the first prompt to speed up the recognition process for the second and subsequent prompts. To compensate for the fact that this may increase the possibility of subsequent interpretation errors if an interpretation error has occurred in the processing of the user's response to the first prompt, the dialogue apparatus allows for the interpretation results for previous prompts to be re-evaluated or for the interpretation process to be re-conducted with the prompts re-ordered to avoid propagation of interpretation errors.

As can be seen from the above, the recogniser controller 8 is arranged to determine that an interpretation error has occurred in one or more of the following circumstances:
1. the user provides a negative answer (for example says no) in response to a confirmatory prompt;
2. there is no interpretation result or combination of interpretation results that has a sufficiently high confidence score;
3. the interpretation results for different prompts are inconsistent when the data in the customer information database is taken into consideration.

As set out above, the recogniser controller 8 is configured to provide the following re-evaluation options:
1. to re-evaluate the interpretation results for the already-asked prompts and to select the combination of interpretation results having the next highest confidence score;
2. to re-order the prompts and request the user input recogniser 5 to re-process the stored user response data so that an unconstrained global grammar is made for the response to a different one of the set of prompts.

As another possibility, or additionally, the recogniser controller 8 may adjust the threshold at which the confidence levels of the results provided by the user input recogniser 5 are considered reliable in the event of the detection of an interpretation error. For example, the recogniser controller 8 may lower the confidence level threshold so that results having a lower confidence level are also considered.

In the above-described embodiments, the user uses a landline or mobile telephone to communicate with the dialogue apparatus. It will, of course, be appreciated that the user device 15 may be a personal computer, laptop or personal digital assistant (PDA) configured to be coupled to the network either by a wired or wireless communications link.

In the above described embodiments, the user provides user input data or responses in response to a sequence of prompts. This need not necessarily be the case. For example, a single prompt prompting the user for all the required information may be output. As another possibility, where the user knows what information is required, then the user may simply supply the necessary user input data without the dialog apparatus providing any prompts.

Also, as described above, at least initially, the interpreter 500 interprets user input data in the order in which it is input. In other embodiments, the interpreter 500 may process the user input data in a different order. This allows the interpreter 500 to select the user input data that is most likely to be correctly interpreted as the first user input data item to be interpreted while still allowing the user to input data in a more natural manner. Thus, in the examples given above, the interpreter 500 may interpret postcode data first as this is of a very specific format and may thus be more easily interpreted even though the user naturally provides the company name as the first user input data item.

In other embodiments, the interpreter need not wait for all of the set of user input data items to have been received but may interpret items of user input data as they are received.

In the above described embodiments, the user provides user input data in the form of speech. Other forms of user input may be provided, dependent upon the user input options provided by the user interface of the user device. Thus, where the user device has a handwriting input, then the user input may be provided in the form of handwriting data in which case the user input recogniser 5 will comprise a handwriting recognition engine. Similarly, if the user interface includes a camera, then user input may be in the form of gesture and/or lip reading data in which case the user input recogniser 5 will have a gesture and/or lip reading data recogniser. Where the user input recogniser 5 is capable of recognising user input data in more than one of the above-mentioned modalities, then the user input recogniser 5 will generally include a modality integrator that enables inputs from different modalities to be combined in accordance with a set of logical rules determining the circumstances (for example the relative timing of the inputs in the different modalities) in which input from different modalities should be combined as representing the answer to a single prompt.

Also, use of the dialogue apparatus may also be advantageous even where the user input is in the form of keystroke data because the user input recogniser 5 and recogniser controller 8 may be able to compensate for typing errors.

As described above, the dialogue apparatus 200 is provided as a single physical entity. It will, however, be appreciated that the functional components of the dialogue apparatus may be distributed across the network so that the functional components communicate via the network. Thus, for example, the user input actioner 11 may be located on a different part of the network from the remaining parts of the dialogue apparatus. Similarly, the user input recogniser 5 may be located on a different part of the network from the recogniser controller 8 as may the operations and dialogue controllers 14 and 1. In addition, the customer information database 10 may be located at a different location on the network and the recogniser controller 8 arranged to access the customer information database 10 over the network. Similarly, any one or more of the dialogue store 2, recognition grammar store 6, user response data store 7 and interpretation results data store 9 may be accessed over the network.

In the above-described embodiments, a user communicates with the dialogue apparatus over a network. This need not necessarily be the case and, for example, a user may communicate directly with the dialogue apparatus using the user interface shown in FIG. 4b. As another possibility, the dialogue apparatus may be a standalone apparatus and the user may communicate directly with the dialogue apparatus or via a user device 15 coupled to the dialogue apparatus via a wired or wireless communications link.

In the above-described embodiments, examples of transactions that may be completed using the dialogue apparatus have been given. It will, however, be appreciated that the dialogue apparatus may be used in any circumstance where a customer information database is amendable and it is required to ask a number of prompts of a user to elicit information to enable a user's instructions to be implemented.

In addition to avoiding or reducing the possibility of having to ask a user a repeat prompt, the dialogue apparatus described above may have additional advantages. Thus, for convenience of the user, a sequence of prompts can be tailored to the order in which the user would expect to be asked for information. However, it may be that responses to certain prompts can be recognised more reliably than responses to other prompts. Thus, for example, in the telephone photocopier usage logging system described above, the recognition results should be better for the serial numbers than for the company names because the serial numbers all conform to a standard format. A user, however, naturally expects to be asked their company name before the serial number. Using the dialogue apparatus 200 described above enables advantage to be taken of the fact that the serial numbers can be more accurately recognised than the company names while still enabling the prompts to be presented to the user in the order that seems most natural to users.

In addition, automatic speech recognition engines cannot necessarily always detect the true end point of user's speech data particularly if the user pauses unnaturally whilst speaking. Storing the digital speech data in the user response data files has the advantage that speech data separated by pauses can be concatenated so that account can be taken of the possibility of an end point detection error.

1. Apparatus for processing a set of items of related user input data to facilitate the carrying out of a task, the apparatus comprising:
a receiver operable to receive items of user input data;
an interpreter operable to interpret the set of items of user input data to produce a corresponding set of interpretation results data including interpretation results data for each item of user input data, the interpreter being configured to constrain interpretation of an item of the set of user input data on the basis of constraint data related to the interpretation results data obtained for at least one other item of the set of user input data items; and
a controller operable to detect an occurrence of a interpretation error in the interpretation results data for an item in the set of user input data items, the controller being configured to cause, in the event that an interpretation error is detected for an item in the set of user input data items, the interpreter to re-interpret at least one of the other items in the set of user input data items using modified constraint data to produce modified interpretation results data and the controller also being operable to provide a control signal to facilitate the carrying out of a task in accordance with the set of modified interpretation results data.

2. Apparatus according to claim 1, wherein the interpreter is configured to interpret the user input data items using a database containing data associated with the user input data items and providing the constraint data.

3. Apparatus according to claim 1, further comprising a prompter operable to supply to the user prompt data for prompting the user to supply the user input data items.

4. Apparatus for conducting a dialog with a user regarding the carrying out of a task, the apparatus comprising:
a prompter operable to supply a set of prompt data for prompting the user to supply a corresponding set of items of user input data for acquiring task data to enable the task to be carried out;
a receiver operable to receive user input data items representing the user's responses to the set of prompt data;
an interpreter operable to interpret the user input data items to obtain a set of interpretation results data for providing the task data to enable the task to be carried out, the interpreter being configured to interpret the user input data items using a database containing data relevant to the set of prompt data and to constrain the interpretation of an item of the set of user input data items to interpretation results data that, according to the data in the database accessed by the interpreter, are consistent with the interpretation results data for a user input data item or user input data items of the set that have already been interpreted; and
a controller configured to identify an occurrence of an interpretation error in the interpretation results data for a user input data item on the basis of at least one of the interpretation results data and the data in the database and being configured to cause the interpreter to re-interpret at least one user input data item in the set other than the user input data item for which the occurrence of an interpretation error was detected using modified constraints in the event that an interpretation error occurrence is identified, the controller being operable to instruct the carrying out of the task in accordance with the modified set of interpretation results data.

5. Apparatus according to claim 4, wherein the interpreter is arranged to identify an interpretation error in the event that interpretation results data are inconsistent with data in the database.

6. Apparatus according to claim 1, wherein the interpreter is configured to store a group of interpretation results data for each user input data item, the controller is operable to select interpretation results data for a user input data item from within the corresponding stored group of interpretation results data and to modify the constraint data for a user input data item in the case of an occurrence of an interpretation error for a user input data item by selecting different interpretation results data for that user input data item and by causing the interpreter to re-interpret at least one other user input data item in the set of user input data items such that the interpretation results data produced for the at least one other user input data item in the set of user input data items are constrained to interpretation results data that are consistent with the different interpretation results data for that user input data item.

7. Apparatus according to claim 1, wherein the controller is operable to cause the at least one user data input item for which the constraints on the interpretation results data are modified to be the user data input item that was interpreted immediately preceding the user input data item for which the occurrence of an interpretation error was detected.

8. Apparatus according to claim 1, wherein the interpreter is operable to provide a set of interpretation results data for each user input data item with each interpretation results data being associated with a confidence score and to store the confidence scores with the interpretation results data, the interpreter is operable to select from the set of interpretation results data the interpretation results data having a confidence score above a predetermined threshold and the controller is operable to cause the predetermined threshold to be adjusted for the at least one user input data item in the case that an occurrence of an interpretation error is detected.

9. Apparatus according to claim 1, wherein the controller is operable to cause the constraints on the interpretation results data to be modified for the at least one user input data item of the set of user input data items in the case that the interpreter detects an occurrence of an interpretation error by causing the interpreter to interpret the user input data items in a different order.

10. Apparatus according to claim 1, wherein the interpreter is arranged to interpret user input data items using a recognition grammar and the controller is operable to constrain the recognition grammar for a subsequent user input data item to recognition grammar data that are consistent with the interpretation results data obtained for at least one other user input data item.

11. Apparatus according to claim 10, further comprising the recognition grammar.

12. Apparatus according to claim 11, wherein the recognition grammar provides a respective different recognition grammar file for each user input data item.

13. Apparatus according to claim 2, wherein the interpreter is arranged to access as the database a database containing, for each user input data item, sets of potential interpretation results data items with each potential interpretation results data item being provided with association data associating that potential interpretation results data item with one or more potential interpretation results data items for a different one of the set of user input data items.

14. Apparatus according to claim 2, further comprising the database, wherein the database contains, for each user input data item, a set of potential interpretation results data items with each potential interpretation results data item being provided with association data associating that potential interpretation results data item with one or more potential interpretation results data items for a different one of the set of user input data items.

15. Apparatus according to claim 14, wherein each potential interpretation results data item is provided with association data associating that potential interpretation results data item with one or more potential interpretation results data items for each of the other ones of the set of user input data items.

16. Apparatus according to claim 1, wherein the controller is arranged to cause the user to be requested to supply a confirmatory user input data item in the event that the controller does not detect or no longer detects an occurrence of an interpretation error for the set of user input data items and the controller is arranged to identify an interpretation error in the event that the interpretation results data for the confirmatory user input data item indicate that the user has not confirmed that the set of user input data items have been interpreted correctly.

17. Apparatus according to claim 1, wherein the controller is operable to instruct the interpreter to re-interpret the interpretation results data for the first of the set of user input data items in the event the controller detects an occurrence of an interpretation error in the interpretation results data for that first user input data item.

18. Apparatus according to claim 1, wherein the interpreter comprises a speech recogniser.

19. Apparatus according to claim 1, adapted to enable a user to supply data relating to usage of an office machine such as a photocopier to enable a task related to logging of that usage with the office machine provider to be carried out.

20. Apparatus according to claim 14, wherein the database contains company data, machine serial number data and address-related data and the user input data items comprise a company name, a machine serial number and address-related data.

21. A method of processing a set of items of related user input data to facilitate the carrying out of a task, the method comprising apparatus carrying out the steps of:
receiving items of user input data;
interpreting the set of items of user input data to produce a corresponding set of interpretation results data including interpretation results data for each item of user input data such that interpretation of an item of the set of user input data is constrained on the basis of constraint data related to the interpretation results data obtained for at least one other item of the set of user input data items;
detecting an occurrence of an interpretation error in the interpretation results data for an item in the set of user input data items;
in the event that an interpretation error is detected for an item in the set of user input data items, re-interpreting at least one of the other items in the set of user input data items using modified constraint data to produce modified interpretation results data; and
providing a control signal to facilitate the carrying out of a task in accordance with the set of modified interpretation results data.

22. A method according to claim 21, wherein the interpreting step interprets the user input data items using a database containing data associated with the user input data items and providing the constraint data.

23. A method according to claim 21, further comprising the step of prompting the user to supply the user input data items.

24. A method of conducting a dialog with a user regarding the carrying out of a task, the method comprising a dialog apparatus carrying out the steps of:
supplying a set of prompt data for prompting the user to supply a corresponding set of items of user input data for acquiring task data to enable the task to be carried out;
receiving user input data items representing the user's responses to the set of prompt data;
interpreting the user input data items to obtain a set of interpretation results data for providing the task data to enable the task to be carried out, by using a database containing data relevant to the set of prompt data and constraining the interpretation of an item of the set of user input data items to interpretation results data that, according to the data in the accessed database, are consistent with the interpretation results data for a user input data item or user input data items of the set that have already been interpreted;
identifying an occurrence of an interpretation error in the interpretation results data for a user input data item on the basis of at least one of the interpretation results data and the data in the database;
re-interpreting at least one user input data item in the set other than the user input data item for which the occurrence of an interpretation error was detected using modified constraints in the event that an interpretation error occurrence is identified; and
instructing the carrying out of the task in accordance with the modified set of interpretation results data.

25. A method according to claim 24, wherein the interpreting step identifies an interpretation error in the event that interpretation results data are inconsistent with data in the database.

26. A method according to claim 21, wherein the interpreting step stores a group of interpretation results data for each user input data item, interpretation results data for a user input data item are selected from within the corresponding stored group of interpretation results data, the constraint data for a user input data item is modified in the case of an occurrence of an interpretation error for a user input data item by selecting different interpretation results data for that user input data item, and at least one other user input data item in the set of user input data items is re-interpreted such that the interpretation results data produced for the at least one other user input data item in the set of user input data items are constrained to interpretation results data that are consistent with the different interpretation results data for that user input data item.

27. A method according to claim 21, wherein the at least one user data input item for which the constraints on the interpretation results data are modified is the user data input item that was interpreted immediately preceding the user input data item for which the occurrence of an interpretation error was detected.

28. A method according to claim 21, wherein the interpreting step provides a set of interpretation results data for each user input data item with each interpretation results data being associated with a confidence score and stores the confidence scores with the interpretation results data, the interpretation results data having a confidence score above a predetermined threshold are selected from the set of interpretation results data and the predetermined threshold is adjusted for the at least one user input data item in the case that an occurrence of an interpretation error is detected.

29. A method according to claim 21, wherein the constraints on the interpretation results data are modified for the at least one user input data item of the set of user input data items in the case that an occurrence of an interpretation error is detected by causing the interpreter to interpret the user input data items in a different order.

30. A method according to claim 21, wherein the interpreting step interprets user input data items using a recognition grammar and the recognition grammar for a subsequent user input data item is constrained to recognition grammar data that are consistent with the interpretation results data obtained for at least one other user input data item.

31. A method according to claim 30, wherein the recognition grammar provides a respective different recognition grammar file for each user input data item.

32. A method according to claim 22, wherein the interpreting step accesses as the database a database containing, for each user input data item, sets of potential interpretation results data items with each potential interpretation results data item being provided with association data associating that potential interpretation results data item with one or more potential interpretation results data items for a different one of the set of user input data items.

33. A method according to claim 32, wherein each potential interpretation results data item is provided with association data associating that potential interpretation results data item with one or more potential interpretation results data items for each of the other ones of the set of user input data items.

34. A method according to claim 21, further comprising requesting the user to supply a confirmatory user input data item in the event an occurrence of an interpretation error for the set of user input data items is not detected or is no longer detected and identifying an occurrence of an interpretation error in the event that the interpretation results data for the confirmatory user input data item indicate that the user has not confirmed that the set of user input data items have been interpreted correctly.

35. A method according to claim 21, wherein the interpretation results data for the first of the set of user input data items are re-interpreted in the event the controller detects an occurrence of an interpretation error in the interpretation results data for that first user input data item.

36. A method according to claim 21, wherein the interpreting step comprises recognising user input data in the form of speech data.

37. A method according to claim 21 for enabling a user to supply data relating to usage of an office machine such as a photocopier to enable a task related to logging of that usage with the office machine provider to be carried out.

38. A method according to claim 37, wherein the database contains company data, machine serial number data and address-related data and the user input data items comprise a company name, a machine serial number and address-related data.

39. An interpreter apparatus for use in an apparatus in accordance with claim 1, comprising:
an interpreter operable to interpret a set of items of user input data to produce a corresponding set of interpretation results data including interpretation results data for each item of user input data, the interpreter being configured to constrain interpretation of an item of the set of user input data on the basis of constraint data related to the interpretation results data obtained for at least one other item of the set of user input data items; and
a controller operable to detect an occurrence of an interpretation error in the interpretation results data for an item in the set of user input data items, the controller being configured to cause, in the event that an interpretation error is detected for an item in the set of user input data items, the interpreter to re-interpret at least one of the other items in the set of user input data items using modified constraint data to produce modified interpretation results data.

40. A method of interpreting user input data, comprising the steps of:
interpreting a set of items of user input data to produce a corresponding set of interpretation results data including interpretation results data for each item of user input data, the interpreter being configured to constrain interpretation of an item of the set of user input data on the basis of constraint data related to the interpretation results data obtained for at least one other item of the set of user input data items;
detecting an occurrence of an interpretation error in the interpretation results data for an item in the set of user input data items; and
causing, in the event that an interpretation error is detected for an item in the set of user input data items, at least one of the other items in the set of user input data items to be re-interpreted using modified constraint data to produce modified interpretation results data.

41. A signal comprising processor-implementable instructions for programming a processor to carry out a method in accordance with claim 21.

42. A storage medium storing processor-implementable instructions for programming a processor to carry out a method in accordance with claim 21.

43. Apparatus for processing a set of items of related user input data to facilitate the carrying out of a task, the apparatus comprising:
receiving means for receiving items of user input data;
interpreting means for interpreting the set of items of user input data to produce a corresponding set of interpretation results data including interpretation results data for each item of user input data, and for constraining interpretation of an item of the set of user input data on the basis of constraint data related to the interpretation results data obtained for at least one other item of the set of user input data items; and
control means for detecting an occurrence of a interpretation error in the interpretation results data for an item in the set of user input data items, for causing, in the event that an interpretation error is detected for an item in the set of user input data items, the interpreting means to re-interpret at least one of the other items in the set of user input data items using modified constraint data to produce modified interpretation results data and for providing a control signal to facilitate the carrying out of a task in accordance with the set of modified interpretation results data.

44. Apparatus for conducting a dialog with a user regarding the carrying out of a task, the apparatus comprising:
prompt means for supplying a set of prompt data for prompting the user to supply a corresponding set of items of user input data for acquiring task data to enable the task to be carried out;
receiving means for receiving user input data items representing the user's responses to the set of prompt data;
interpreting means for interpreting the user input data items to obtain a set of interpretation results data for providing the task data to enable the task to be carried out, by using a database containing data relevant to the set of prompt data and constraining the interpretation of an item of the set of user input data items to interpretation results data that, according to the data in the database accessed by the interpreting means, are consistent with the interpretation results data for a user input data item or user input data items of the set that have already been interpreted; and
control means for identifying an occurrence of an interpretation error in the interpretation results data for a user input data item on the basis of at least one of the interpretation results data and the data in the database, for causing the interpreting means to re-interpret at least one user input data item in the set other than the user input data item for which the occurrence of an interpretation error was detected using modified constraints in the event that an interpretation error occurrence is identified, and for instructing the carrying out of the task in accordance with the modified set of interpretation results data.

45. An interpreter apparatus for use in an apparatus in accordance with claim 1, comprising:
interpreting means for interpreting a set of items of user input data to produce a corresponding set of interpretation results data including interpretation results data for each item of user input data, and for constraining interpretation of an item of the set of user input data on the basis of constraint data related to the interpretation results data obtained for at least one other item of the set of user input data items; and
control means for detecting an occurrence of an interpretation error in the interpretation results data for an item in the set of user input data items, and for causing, in the event that an interpretation error is detected for an item in the set of user input data items, the interpreting means to re-interpret at least one of the other items in the set of user input data items using modified constraint data to produce modified interpretation results data.
